(19) United States
(12) Patent Application Publication
(10) Pub. No.: US 2011/0276967 A1
(43) Pub. Date: Nov. 10, 2011

(54) Method and System for Enabling Computer Systems to Be Responsive to Environmental Changes

(76) Inventor: Hazim Ansari, Tustin, CA (US)

(21) Appl. No.: 12/940,900

(22) Filed: Nov. 5, 2010

Related U.S. Application Data
(63) Continuation of application No. 11/612,803, filed on Dec. 19, 2006, now abandoned.
(60) Provisional application No. 60/751,726, filed on Dec. 19, 2005.

(51) Int. Cl. G06F 9/46

(52) U.S. Cl. 718/100

(57) ABSTRACT

The present invention discloses a method and system for automatically enabling a computer to preserve data in response to an environmental change, respond to motion or sound, or be responsive to the arrival or actions of a person. In one embodiment, the computer monitoring system comprises at least one sensor for determining the existence of motion external to a computer where, upon detecting motion, the sensor communicates a signal to a receiver, which is in data communication with the computing device, and a program coupled to the receiver where the program comprises routines for receiving user input defining what programs or files to close, open, play, minimize, or maximize upon receiving a signal from the receiver.

### CROSS-REFERENCE

The present application calls priority to U.S. Provisional Application No. 60/751,726 filed on Dec. 19, 2005.

### FIELD OF THE INVENTION

The present invention relates generally to the field of computer applications and more specifically, to methods and systems for enabling computer systems to be responsive to environmental changes, such as motion, fire, floods, earthquakes, or other physical events.

### BACKGROUND OF THE INVENTION

For many households and businesses, computer systems contain critical information and important assets, such as photos, videos, and other records. It is critical that these assets be properly protected against calamities such as fire, earthquakes, floods, or other physical events. Current security systems focus on providing security against electronic threats, such as viruses, or protecting against physical damages by periodic data backups.

These systems have a critical disadvantage, however. Because the data backup occurs on a periodic timer, not triggered by an actual threat, data generated between the last backup and the occurrence of the threat, i.e. fire, earthquake, or flood, is often lost. It would therefore be preferred to have the computer be responsive to physical changes in its environment so that it can take the requisite actions to protect important data.

In addition to being responsive to physical threats, it would be preferable to have computer systems be responsive to simple changes in its physical environment, such as sound or motion. Accessing e-mails and browsing the Internet are amongst the most prevalent uses of computers. People use computers for these purposes at their homes, offices and cyber cafes, and at public places such as airports and during travel in case the computer being used is a portable one.

Privacy is a major issue when a person is not using a computer in a solitary environment. For example, in an office environment, people not only want to prevent unauthorized access to their computers while they are not on their seats, but are also uncomfortable with their co-workers being able to see whatever they are doing on their computers.

The use of a screen saver is known to prohibit unauthorized access to a computer without inputting an appropriate password, but it is not useful when a user wants to shut down or minimize windows on the display before another person can see what they're doing. In such a scenario, even manual shut down or minimization of windows proves ineffectual, as it takes a long time and requires sufficiently advance forewarning. Further, closing down a window abruptly when a third person approaches may even result in loss of important data.

Immediate shutdown applications are known to exist in the art, wherein a person presses one or two keys to lock down the whole computer or shut down several programs. Programs to hide some or all of the windows in the main display screen as well as in the task bar and system tray are also known. However, all these software programs still require a person to have sufficient forewarning that another person is approaching or is present.

Therefore, there is a need for an adequate methods and systems that enable a computer system to automatically protect a user's privacy when certain changes in the physical environment, such as motion or sound, is detected.

### BRIEF DESCRIPTION OF THE DRAWINGS

These and other features and advantages of the present invention will be further appreciated, as they become better understood by reference to the following detailed description when considered in connection with the accompanying drawings:

FIG. 1 is a block diagram depicting the overview of one embodiment of the present invention;

FIG. 2 is a flowchart illustrating the operation of one embodiment of the present invention;

FIG. 3 is a diagram depicting an exemplary screen of the Graphical User Interface (GUI) as used in one embodiment of the system of present invention;

FIG. 4 is a flowchart illustrating the operation of one embodiment of the present invention; and

FIG. 5 is a flowchart illustrating the operation of one embodiment of the present invention.

### SUMMARY OF THE INVENTION

The present invention discloses a method and system for automatically enabling a computer to preserve data in response to an environmental change, respond to motion or sound, or be responsive to the arrival or actions of a person. In one embodiment, the computer monitoring system comprises at least one sensor for determining the existence of motion external to a computer wherein, upon detecting motion, said sensor communicates a signal to a receiver, which is in data communication with a computing device wherein said receiver is capable of receiving said signal from the at least one sensor; and a program coupled to said receiver and stored in a memory coupled to the computing device, wherein said program comprises routines for receiving user input defining what programs or files to close, open, play, minimize, or maximize upon receiving a signal from said receiver.

Optionally, the motion sensor further comprises a reader for receiving data about a person and the signal communicated by said sensor includes said data. Optionally, the program further comprises routines for receiving user input defining what programs or files to close, open, play, minimize, or maximize responsive to said data about a person. Optionally, the program further comprises routines for restoring the programs and files present on said computer to a state prior to the detection of motion by the at least one sensor. Optionally, the program further comprises routines for instructing an operating system of the computing device to close, open, play, minimize, or maximize a particular program or file.

### DETAILED DESCRIPTION OF THE INVENTION

The present invention discloses a method and system for automatically enabling a computer to preserve data in response to an environmental change, respond to motion or sound, or be responsive to the arrival or actions of a person. The present invention will be described with reference to aforementioned drawings. One of ordinary skill in the art would appreciate that the applications described herein are examples of how the broader concept can be applied.

In one embodiment, the system of present invention automatically detects the presence or arrival of a third person and takes appropriate action to maintain the privacy of user or be responsive to the identity of the third person.

As used herein, the term computer broadly encompasses any type of computing device that could be placed in data communication with a network. For example, the computer could be any one of a personal computer, laptop, personal data assistant, mobile phone, wireless email manager, media player, computing tablet, set-top box, networked DVD player, or other type of network access device. Each of said devices has a processor, memory, and a communication interface, such as a modem or Ethernet port.

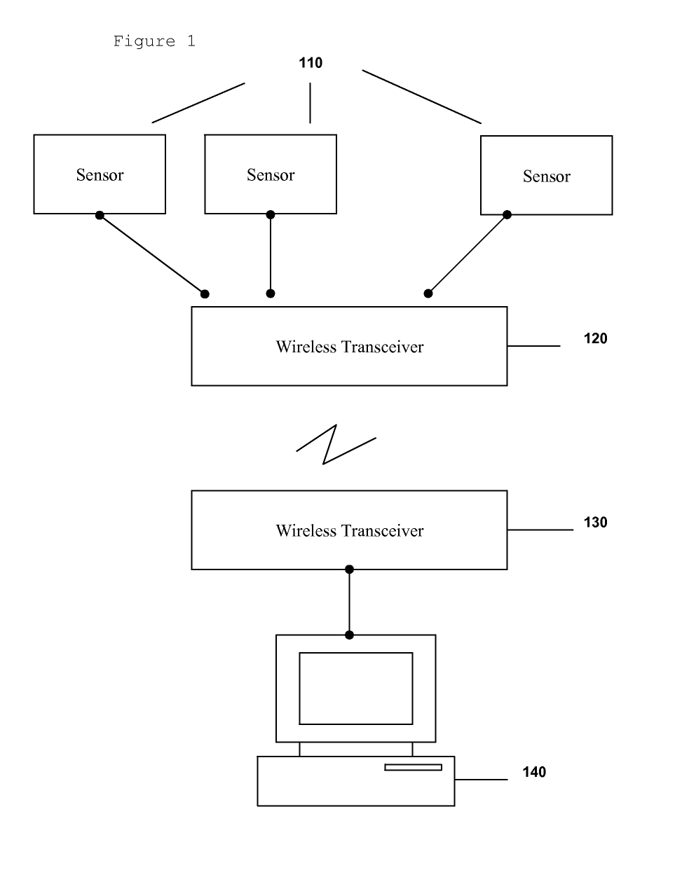

Referring to FIG. 1, an overview of the system of present invention is shown by means of a block diagram. The system comprises a plurality of sensors 110, which are strategically placed in a doorway or corridor, or facing other entry points of a room, office, or other area. The sensors can be of any type, motion or sound sensors. Preferably, the sensors employed with the system of present invention are small enough to be inconspicuous and capable of being glued or otherwise attached to any surface. Also preferably, the sensors are capable of being wirelessly activated by the computer 140 or are turned on and off using a small manual switch.

In one embodiment the sensor further comprises a reader capable of reading an RFID tag, smart card, or other identifying device. Therefore, in addition to detecting the presence of motion or sound, the sensor can specifically detect the identity of a person, a person's personal data, such as age, sex, tastes, preferences, security clearance, or other information, and transmit information derived from such data.

All the sensors 110 are connected to a wireless transceiver 120, which may be integrated with the sensors or located separate, but proximate, to the motion sensors. The wireless transceiver 120 associated with the sensors further communicates with another wireless transceiver 130, which is connected to the user's computer 140. The wireless transceiver 130 connected to the user's computer can be in any form, such as a USB based wireless transceiver or built in wireless communication systems as a network card.

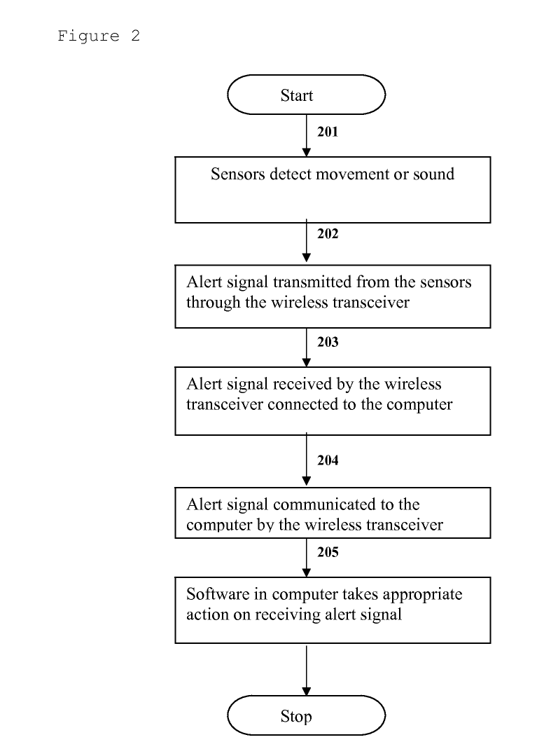

The computer 140 executes a software program that takes appropriate actions to protect the user's privacy on receiving alert signals from any of the sensors or to tailor the executing programs on the computer to the person(s) who activate, or interact with, the sensors. FIG. 2 is a flowchart explaining the operation of the system described in FIG. 1. Referring to FIG. 2 (and referring back to FIG. 1), when the computer 140 is in use, all the other components of the system, such as the wireless transceivers 120 and 130 and the motion sensors 110, preferably remain active. Therefore, as soon as a person approaches an entry point of the room in which the computer is placed, the sensors located along that entry point detect the movement or sound, depending on the sensors being used. This is illustrated in step 201. As a result, an alert signal is transmitted from the specific sensor(s) by means of the associated wireless transceiver 120, as shown in step 202. This alert signal is received by the wireless transceiver 130 connected to the computer. This is depicted in step 203. One of ordinary skill in the art would appreciate that communication between the sensors and the computer, through the wireless transceivers may be carried out in accordance with any suitable wireless protocol such as Bluetooth, Home RF, IrDA, IEEE 802.11 or other wireless application protocol specifications. The alert signal from the motion sensors received by the wireless transceiver 130 is communicated to the computer 140. This is depicted in step 204. The computer hosts a software program that is programmed to respond to the alert signal.

The precise actions executed by the software in response to the alert signal can be customized according to the user's requirements. Thus, as shown in step 205, on receiving the alert signal, the software takes appropriate action as specified by the user. This action may include several tasks such as, but not limited to, shutting down all programs running on the computer, shutting down some programs, minimizing all program windows, minimizing some program windows, launching certain programs, playing certain video or audio files, or shutting down the computer. Further, the software may be programmed to restore all the minimized windows automatically with a single action, such as a key stroke or clicking on an icon.

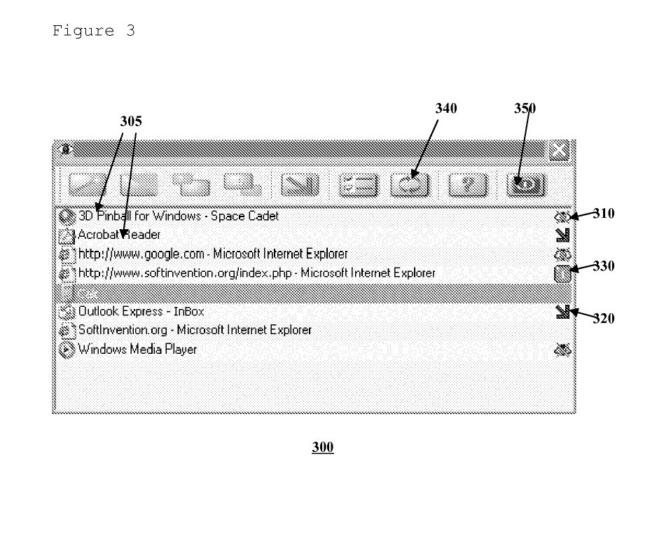

FIG. 3 depicts an exemplary screen of the graphical user interface (GUI) 300 for the software described above. As shown in the figure, the GUI screen 300 lists all the active applications 305 on the user's computer. Menus and buttons 310, 320, 330, 340, 350 provided on the GUI help the users to customize the software to perform various tasks to suit their needs. Thus, a user can select some or all of the applications, which he or she wants to be minimized 320 or closed 310 when a sensor is triggered. The GUI also allows the user to create a list of programs that will be launched or opened 330 on receiving a signal from a sensor. Similarly, through the GUI, the software can be configured by the user to perform other tasks such as shutting down the computer or putting it on standby. One ordinary skill in the art would appreciate that the software is capable of being readily activated or deactivated by the user. The software program can be refreshed periodically 340 to update the list of active applications.

Preferably, a user pre-programs the actions of the computer via the GUI. For example, a user can designate a Word document to open upon the activation of one or more sensors, can designate a web browser window to close upon the activation of one or more sensors, can designate another application window to minimize, or can designate another application window to open. One of ordinary skill in the art would appreciate that any application or file can be designated as being opened, closed, minimized or maximized upon the activation of a sensor.

As one of ordinary skill in the art would appreciate, the software program comprises programming code, or routines, stored on a fixed medium, such as the memory or hard disk of the computing device. It can typically provide the functions described above by comprising code that a) receives user input selecting one or more files, programs, images, or other objects to launch, b) receives user input selecting one or more files, programs, images, or other objects to close, c) receives user input selecting one or more files, programs, images, or other objects to minimize, if open, d) receives user input selecting whether to place the computing device on standby or shutting it down, e) receives user input selecting one or more files, programs, images, or other objects to maximize, if open, f) communicates instructions to the operating system of the computing device to launch, close, minimize, or maximize one or more files, programs, images, or other objects, depending upon the user input, and g) communicates instructions to the operating system of the computing device to place it on standby or shut it down.

Additionally, the software program operative on the computer can include other options, such as providing an alert prior to taking any action, providing an alert and waiting to receive a user approval input prior to taking any action, and taking the predesignated actions automatically. Optionally, the software program can automatically bookmark exactly where the user was in each of the closed applications. Therefore, the user can, with a keystroke or clicking of an icon, restore exactly where he was in each of the closed applications, as shown by button 350 in FIG. 3. In one embodiment, the software program automatically restores the user's screen to precisely the form it was in prior to taking the predesignated actions by minimizing, maximizing, opening, or closing files or applications, as the case may be. In another embodiment, the software program restores only the closed applications. In another embodiment, the software program restores only the applications which were not closed.

In another embodiment, the software program can be programmed to launch, minimize, maximize, close, or otherwise tailor files, programs, images, or other objects to the information received from sensors that comprise a reader capable of reading an RFID tag, smart card, or other identifying device. The software program can therefore be programmed, as discussed above, to react to the presence of a specific person or of particular personal data, such as age, sex, tastes, preferences, security clearance, or other information. Therefore, in a party, conference, or public setting, displays, which may be remotely communicating with a hard drive, can be programmed to play videos, audio files, or images in response to the personal demographic profile of one or more people.

The use of the system of present invention may be extended to portable computers such as laptops and palmtops as well. If the portable computer is being used in a stationary location, such as at the user's home or office, then it may be configured to communicate by means of wireless transceivers, with sensors installed at entry points. However, in case the portable computer is being used in a public place such as at an airport, or during travel, then it may be configured to execute the software program of the present invention, without communicating with sensors. In this case, the software may be programmed to perform all the activities described above on receiving a suitable input, such as a particular key stroke, from the user, instead of receiving an alert signal from the motion sensors.

Thus, in its application for portable computers, the software employed with the present invention may be programmed to operate in two modes—stationary mode, wherein it takes appropriate action based on inputs from available sensors, and mobile mode, wherein the software automatically executes user-specified tasks on receiving suitable input from the user.

Data Protection

In another embodiment, the present invention is directed to a computer system that is responsive to environmental changes and, depending on the established predesignated actions, takes certain actions to protect data.

The software program provides for the following actions:

1. Save all files and close all applications.

2. Package, in compressed form, some or all of the user's data files.

3. Transmit, in compressed form, some or all of the user's data files.

4. Perform the packaging and transmission based on a priority hierarchy established by the user (i.e. financial records first, then family photos and videos, then emails, then word documents, and finally archived files).

5. Shut down the computer

As shown in FIG. 1, the environmental sensors, such as smoke detectors, communicate wirelessly with a computer. Upon the sensing of a threatening event, such as a fire, the sensor transmits a warning signal to the computer. Once the computer receives it, it can then take a series of predesignated actions, as described above.

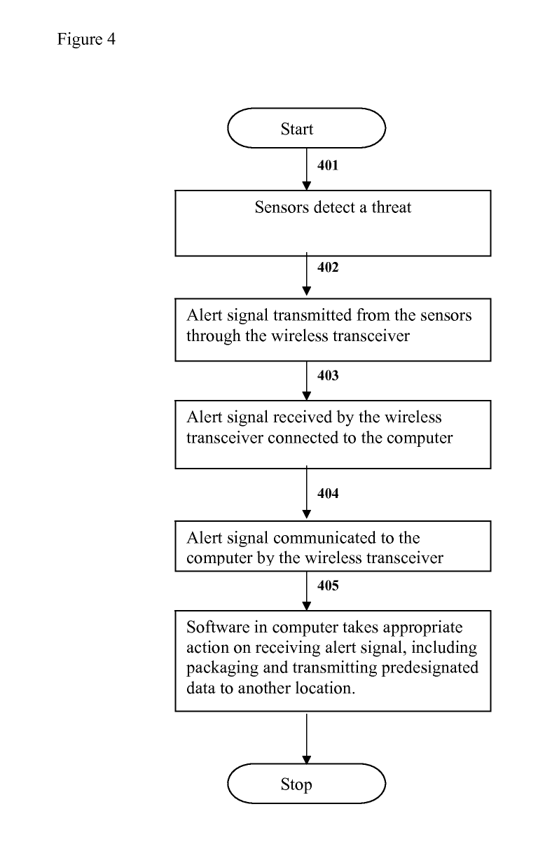

In one embodiment, shown in FIG. 4, the user subscribes to a storage service. When sensors proximate to the computer's location detects an event, such as fire, earthquakes, or floods, the computer automatically responds by packaging data and transmitting it to a remote storage location. The remote storage location could be a remotely located server that is only accessible by authorized users. Once a period of time passes, the storage service can contact the user and provide him or her with the following options, each of which may be associated with an additional charge:

1. Put all of the data onto a new computer (of user's designation) and ship to the user.

2. Store the data, or a portion thereof, for a specific period of time or indefinitely.

3. Burn the data to a plurality of CDs and ship them to an address.

4. Transmit the data to a specific IP address.

5. Delete the data.

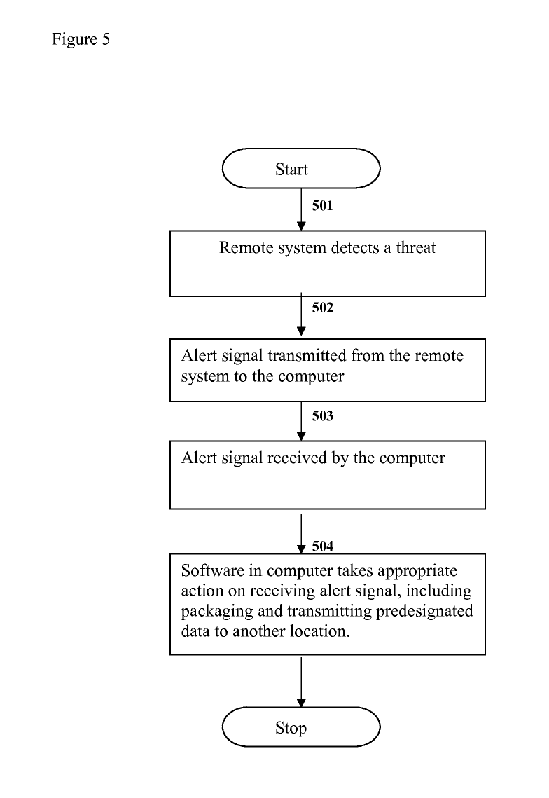

In another embodiment, shown in FIG. 5, the user subscribes to a warning and storage service. When a system remote to the user's computer determines that a threat may exist proximate to the computer's location, such as fire, earthquakes, tornado, or floods, the remote system sends a signal to the computer which, in turn, automatically responds by packaging data and transmitting it to a remote storage location. The remote storage location could be a remotely located server that is only accessible by authorized users. Once a period of time passes, the storage service can contact the user and provide him or her with the following options, each of which may be associated with an additional charge:

1. Put all of the data onto a new computer (of user's designation) and ship to the user.

2. Store the data, or a portion thereof, for a specific period of time or indefinitely.

3. Transmit the data to a specific IP address.

4. Delete the data.

Other features can be preprogrammed as well, such as a user override that stops the packaging and transmission or automatically triggers the packaging and transmission in the absence of a sensor trigger.

In another embodiment, the user may integrate an existing fire or intruder alarm system with the present system. When an existing fire or intruder alarm system determines that a threat may exist proximate to the computer's location, such as fire, theft, or vandalism, the system sends a signal to the computer which, in turn, automatically responds by packaging data and transmitting it to a remote storage location. The remote storage location could be a remotely located server that is only accessible by authorized users. Once a period of time passes, the storage service can contact the user and provide him or her with the options, as described above.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention is not to be limited to the details given herein.

We claim:

1. A computer monitoring system comprising:
a. at least one sensor for determining the existence of motion external to a computer wherein, upon detecting motion, said sensor communicates a signal to a receiver;
b. the receiver in data communication with a computing device wherein said receiver is capable of receiving said signal from the at least one sensor; and
c. a program coupled to said receiver and stored in a memory coupled to the computing device, wherein said program comprises routines for receiving user input defining what programs or files to close, open, play, minimize, or maximize upon receiving a signal from said receiver.

2. The monitoring system of claim 1 wherein said motion sensor further comprises a reader for receiving data about a person.

3. The monitoring system of claim 2 wherein the signal communicated by said sensor includes said data.

4. The monitoring system of claim 3 wherein the program further comprises routines for receiving user input defining what programs or files to close, open, play, minimize, or maximize responsive to said data about a person.

5. The monitoring system of claim 1 wherein the program further comprises routines for restoring the programs and files present on said computer to a state prior to the detection of motion by the at least one sensor.

6. The monitoring system of claim 1 wherein the program further comprises routines for instructing an operating system of the computing device to close, open, play, minimize, or maximize a particular program or file.
